(19) United States
(12) Patent Application Publication
(10) Pub. No.: US 2010/0053300 A1
(43) Pub. Date: Mar. 4, 2010

(54) Method And Arrangement For Video Telephony Quality Assessment

(76) Inventors: Torbjörn Einarsson, Stockholm (SE); Jörgen Gustafsson, Lulea (SE); Gunnar Heikkilä, Gammelstad (SE); Martin Pettersson, Vilentuna (SE); Xiangchun Tan, Trondheim (NO)

Correspondence Address: ERICSSON INC., 6300 LEGACY DRIVE, M/S EVR 1-C-11, PLANO, TX, 75024, US

(21) Appl. No.: 12/525,626

(22) PCT Filed: Feb. 2, 2007
(86) PCT No.: PCT/SE07/51015

§ 371 Date: Nov. 10, 2009

Related U.S. Application Data
(60) Provisional application No. 60/899,038, filed on Feb. 2, 2007.

(51) Int. Cl. H04N 7/14; H04L 12/66

(52) U.S. Cl. 348/14.01; 370/352; 348/E07.077

(57) ABSTRACT

In a method of quality assessment for a multimedia signal comprising video telephony media in a video telephony system, the multimedia signal is received SIO, a plurality of parameters of said multimedia signal are extracted S20, and an objective quality measure is determined S30 for the video telephony media based on representations of at least two of the extracted parameters.

### TECHNICAL FIELD

The present invention generally relates to telecommunication systems in general, specifically to and in particular to quality assessment for video telephony media in such systems.

### BACKGROUND

To ensure good quality of experience for a service, telecommunication system operators (for both wireless and wired networks) use tools and measurements to locate and prevent problems of a network or service at an early stage. With a good tool, the network can also be optimized to allow more users to have “good-enough” experience of the offered services given certain network resources. Some services require only that a few network parameters, such as throughput, be measured to give a good estimate of the quality for the end user. When it comes to media services, such as video telephony, the task of measuring quality of experience is not just as trivial since there are several factors that may contribute to the degraded quality, including the media itself.

The best known way of determining quality of video telephony media is to let a panel of test persons subjectively grade each video telephony call and give a subjective quality score (e.g. MOS). This is of course practically infeasible in a real time scenario. Instead the subjectively perceived video quality can be estimated with an objective quality assessment model.

Most known solutions used for objective video quality assessment are based on video image analysis algorithms running on the decoded video images. Many of these are also useable to measure the quality of video telephony to some extent. The ones giving the best result, the full reference models, require a reference video for comparison. Others rely on estimating the quality by assessing only the degraded video itself.

At present there is a plurality of commercially available products or tools that can be used for assessing the quality for video telephony:
PEVQ from Opticom [1] is a full-reference model based on image analysis. The algorithm outputs a MOS-like score.
VQuad from SwissQual [2] is a full-reference model based on image analysis. SwissQual also has a non-reference model called Vmon. Both can be used for determining video quality.
Optimacy tool from Genista [3] is both a non-reference and a full reference model based on image analysis.

The prior art algorithms based on video image analysis are very computational demanding and require large amount of processing power. Even though many of them can be run in close to real-time, the complexity of the algorithms has then been decreased which probably leads to a worse estimate of video quality.

Many of prior art algorithms are full-reference models requiring a reference video to compare the degraded to. This is not always convenient if one wish to test some other video content. A full-reference model always gives the score for a certain video sequence, not the average score for typical video content. The average score is what a mobile operator (or wired operator) normally wants. Finally, to get a valid score the synchronization between the reference and the degraded video in a full-reference model must also be exact.

Therefore there is a need for methods and arrangements enabling improved objective video telephony quality assessment, and particularly without the need for comparison to a reference video telephony call.

### SUMMARY

The present invention overcomes these and other drawbacks of the prior art arrangements and methods.

According to an aspect, the present invention provides improved quality assessment of video telephony services.

According to a further aspect, the present invention enables objective quality assessment based on a partly decoded video telephony session.

Yet another aspect of the present invention enables a quality assessment model that takes both transmission parameters and coding parameters into consideration.

Briefly, the present invention comprises a method of quality assessment for a multimedia signal comprising video telephony media in a video telephony system, in which a multimedia signal is received (S10), a plurality of parameters representative of said multimedia signal are extracted (S20), and an objective quality measure is determined (S30) for the video telephony media based on representations of at least two of the extracted parameters. Advantages of the present invention comprise:

An improved quality assessment model for video telephony services;
A parametric quality assessment model that does not require that the media is fully decoded.
An objective quality measure of a video telephony session;

### BRIEF DESCRIPTION OF THE DRAWINGS

The invention, together with further objects and advantages thereof, may best be understood by referring to the following description taken together with the accompanying drawings, in which:

FIG. 1 is a schematic block diagram of a system comprising an embodiment of the present invention;

FIG. 2 is a schematic block diagram of a further system comprising an embodiment of the present invention;

FIG. 3 is a schematic flow diagram of an embodiment of a method according to the present invention;

FIG. 4 is a schematic block diagram of an arrangement according to the present invention.

### ABBREVIATIONS

AMR-NB Adaptive Multi Rate-Narrow Band
BLER Block Error Ratio
CRC Cyclic Redundancy Check
CS Circuit Switched
DTX Discontinuous Transmission
GOB Group Of Blocks
MOS Mean Opinion Score
MTU Mobile Test Unit
PS Packet Switched
RTCP Real-Time Control Protocol
RTP Real-Time Protocol

### DETAILED DESCRIPTION

The present invention will be described in the context of a general video telephony system in which a video telephony session (two-way or one-way) is active between a video telephony provider and a receiving arrangement. The receiving arrangement can be a mobile terminal or other mobile equipment (e.g. laptop, PDA, etc.), or a test terminal for assessing the quality of the session and/or system, or an intermediate network node.

In its most general aspect the present invention enables objectively estimating a quality score or measure relating to perceived audio quality, video quality or total quality for a video telephony service or media in a mobile or fixed network by utilizing information from the network itself and from the coding of the actual video telephony media stream. It is then possible to map or compare the objective estimate to a subjective quality score such as a MOS score. In the following disclosure, the term media will be used as encompassing the combination of audio and video.

Consequently, a basic embodiment of the present invention includes determining an objective quality measure for a video telephony stream/media/call in a multimedia signal in a video telephony system. The quality measure is determined based on parameters or representations of parameters extracted from the multimedia signal. The parameters or representations thereof can comprise transmission parameters relating to the radio network, the transport network, and/or coding parameters relating to the actual encoded video telephony session/media/call.

The present invention provides objective estimates of one or more of total quality, video quality or audio quality for a video telephony service based on information extracted from a video telephony session or call.

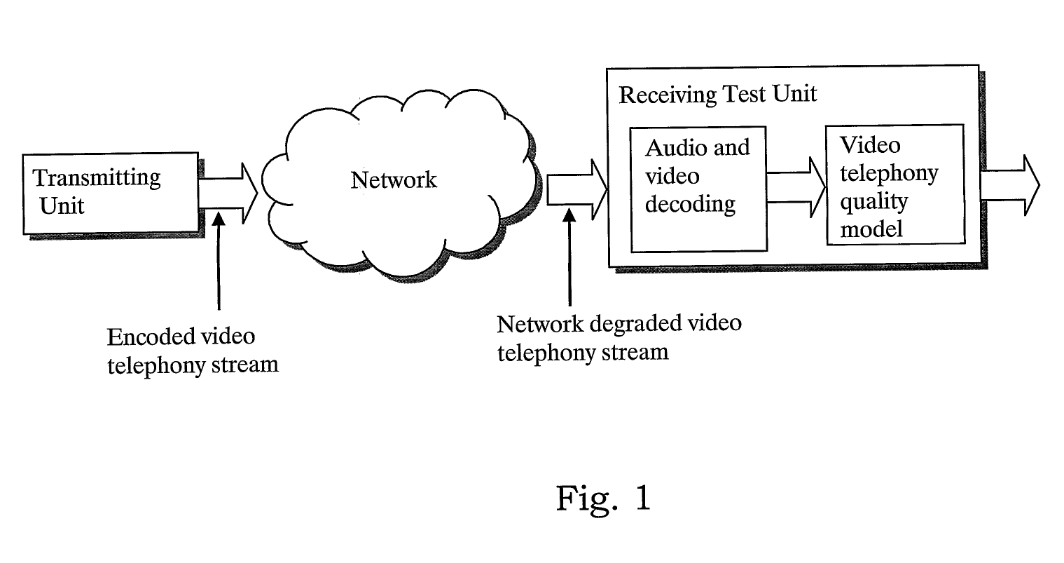

A general system in which the present invention can be implemented is illustrated in FIG. 1, in which a video quality assessment model according to present invention is indicated in the box labeled “Video telephony quality model” that is implemented in a receiving test unit.

The network can be a packet switched (PS) or circuit switched (CS) network or a combination of the two. It could also be some other kind of network or connection, such as a cable. The system can be bidirectional in that a test unit can be both transmitting and receiving.

In a preferred embodiment, the transmitting unit is a mobile device or video telephony server transmitting a video telephony stream or media over a CS mobile network. The receiving test unit is de-multiplexing the stream and decoding the audio and video media of the stream. Given transmission and coding information an estimated quality score, according to the present invention, is calculated.

The network can also be considered a mobile or fixed PS network where the transmitting unit can be a PC-client or a mobile device transmitting audio and video streams separately. The receiver unit, which can be a mobile or PC-client based test unit, is decoding the audio and video streams and calculates an estimated quality score given transport and coding information.

Other possible networks include combinations of the above-mentioned networks.

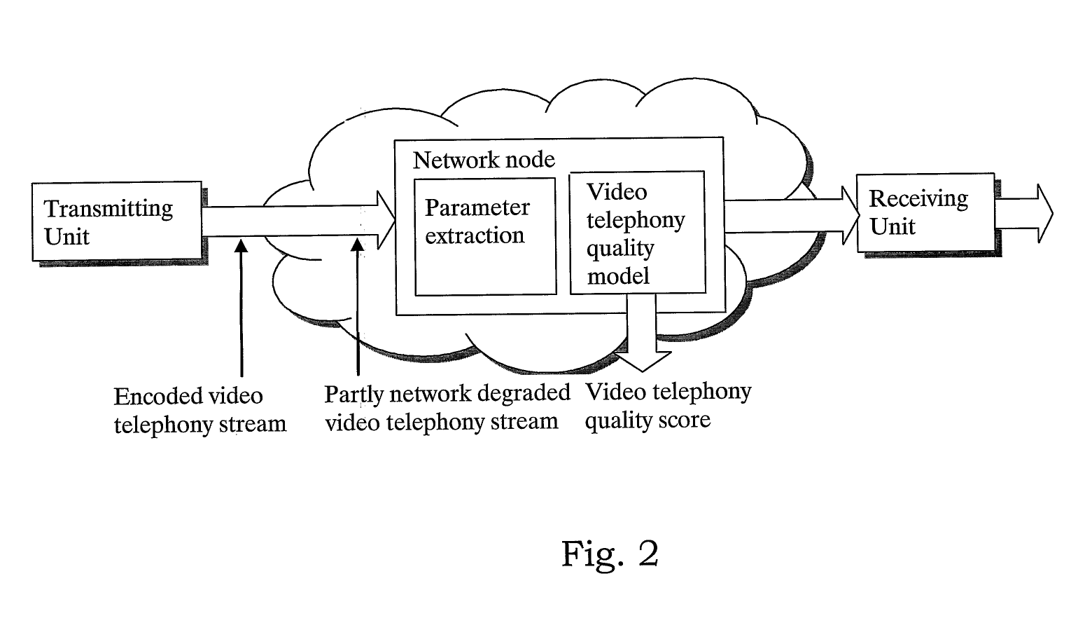

According to a further embodiment, with reference to FIG. 2, the test unit with a video telephony quality model according to the present invention is located in an intermediate network node between the transmitting unit and the receiving unit. This allows for measuring media quality in certain parts of the network. However, if the network is a PS network and the stream is encrypted, limited information can be received from the stream itself.

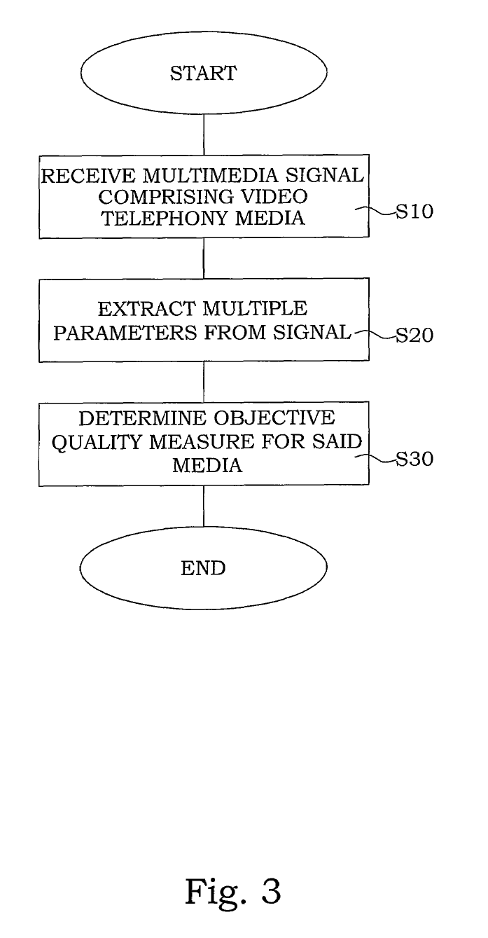

With reference to FIG. 3, an embodiment of a method according to the present invention comprises receiving S10 a multimedia signal in a video telephony system, the multimedia signal comprising video telephony media. Subsequently (or simultaneously) a plurality of parameters are extracted S20 from the received media signal. Finally, an objective quality measure for the video telephony media is determined S30 based on a subset, at least two, of the extracted parameters.

For a particular embodiment, the subset comprises three parameters, i.e. video codec, total coded bitrate and BLER for the received multimedia signal.

Some of the possible parameters or representations of which can be utilized are:

Radio network parameters:
Radio BLER
Radio bearer used

Transport network parameters
Packet loss
Data throughput
Packet jitter data
Packet jitter buffer strategy
IP packet size
RTP/RTCP signaling

Other codec independent parameters:
CRC error ratio for audio and video (from H.223 de-multiplexer)
Number of CRC error for audio and video (similar to the one above)
Total bitrate
Video bitrate
Audio bitrate
Number of bits per video frame
Audio-video synchronization time difference
Target video frame rate
Video type

Codec information
Audio codec (e.g. AMR-NB, G.723)
Video codec (e.g. H.263, MPEG-4, H.264)
Video codec profile
Video codec level

Audio coding dependent parameters
Audio codec mode (e.g. AMR-mode)
Use of DTX or not

Video coding dependent parameters requiring parsing of first couple of bytes in a bit stream
Picture Quantizer
Actual video frame rate (variations are important)
Number of video segments (GOBs, slices, video packets) per frame
Intra or inter picture
Coding tools used

Video coding parameters requiring full bit parsing
Number of intra macro-blocks per picture
Intra refresh strategy (educated guess)
Differential quantizers and average/min/max quantizer per picture
Number of macro-blocks per segment
Average, max and min absolute motion vectors

According to a preferred embodiment, the extracted parameters or representations thereof comprise all parameters above that are marked in bold. The representations can comprise estimates of the parameters or actual measurements thereof. Preferably, representations of all bold parameters are included in the quality measure for the video telephony media.

According to a further embodiment, one or more of the non-bold parameters or representations thereof are included in the quality measure to further improve the accuracy of the quality estimation. Some of the listed parameters can be used to estimate or represent other more vital parameter. As an example, given the radio bearer an assumption of the total bitrate can be determined and used as on of the extracted parameters.

Transport network parameters can be included when the video telephony media streams are transported over a PS network. Some of the network parameters, such as packet loss, are also valid for a CS core network.

Concerning video jitter and video jitter buffers, a brief description is disclosed below. Video packets sent over a PS network are not guaranteed to arrive at an exact or even rate or even in a correct order. Jitter is the term used for a packet stream with uneven arrival rate. Different networks have different jitter distribution and different sized jitter spikes. Depending on buffer size and buffer strategy the consequences of jitter varies from one network to another, or even within the same network.

Some alternative for managing jitter buffers for video:
Use a minimal buffer size. Video streams are played back directly upon arrival which may result in jerkiness when there is a large amount of packet jitter
Use a large buffer size. Video streams are played back at the correct rate but the end-to-end delay is larger. For a real-time service, the delay cannot be too long. The buffer size is thus a tradeoff between acceptable jitter and end-to-end delay.
Use an adaptive buffer size. An adaptive buffer changes the buffer size depending on the jitter characteristics. At low levels, the buffer is reduced and at high levels, it is increased. The speed of the adaptation is an important parameter to set. Depending on the application, the jitter buffer may even select the rate at which a packet following a late packet should be played back, directly or at a somewhat faster pace than real-time until an acceptable delay is restored.

In addition, it is necessary to consider the reality of packets not arriving at all. Consequently, it is necessary to consider how long it is acceptable to wait for a packet before discarding it. This is something that affects the size of the jitter spikes. A discarded video packet results in a so-called spatial artifact.

Concerning coding or codec parameters relating to the actual video telephony stream/media/call, they can be extracted from at least partly decoded (or parsed) received video telephony media streams, or from fully decoded video telephony media streams depending on the model requirements.

According to a specific embodiment, three parameters are extracted from the received multimedia signal.

One possible embodiment of a function for calculation of a quality measure or score Qual_{pred} based on some of the above-mentioned parameters can be expressed as:

Qual_{pred}=ƒ(c,n,r) (1)

where c is a representation of the extracted coding related parameters, n is a representation of the extracted network related parameters, and r is a representation of the extracted parameters affecting the robustness of the video telephony media, and ƒ is a predetermined selected function.

The coding parameters include all parameters relevant to determine the error-free base quality of the video telephony media. If errors are introduced in the network, the network related parameters determine the degradation of quality of the media. The robustness parameters are used to decrease the estimated degradation based on the robustness tools used in the encoding of the media. The robustness parameters may include number of video segments per frame, intra or inter picture information, number of intra macro-blocks per picture and intra refresh strategy.

A basic principle of how the quality score can be calculated is built on the calculated based quality of the clean coded media. The base quality score is then altered to reflect the network degradation and the used robustness tools of the current media. The term clean coded media refers to the theoretical best possible quality for a certain combination of codec, frame rate, bit rate, wherein no transport problems exist.

In another embodiment of the present invention, the quality score function can more specifically be described as a geometrical function:

Qual_{pred}=ƒ(c)*g(r,n) (2)

where ƒ(c) is the quality score for the clean coded media sequence and g(r,n) a value between 0 and 1 reflecting the degradation from the network given the used robustness tools.

In yet another embodiment of the present invention the quality score function can be described as

Qual_{pred}=Qual_{robust} (3)

when

Qual_{clean}=ƒ(c) (4)

Qual_{network}=g(Qual_{clean},n) (5)

Qual_{robust}=h(Qual_{clean},Qual_{network},r) (6)

where ƒ, g and h are suitable selected functions. Qual_{clean} is the quality of the clean coded media. Qual_{network} is the quality of the media after the network degradations. Qual_{robust} is the quality of the media after network degradations with respect of the robustness tools used. The Qual_{clean} score must be used as an input to the Qual_{robust} score to ensure that the quality will not be better than Qual_{clean}. Qual_{robust} may however be less than Qual_{clean} even if Qual_{network}=Qual_{clean} due to that the used robustness tools may introduce extra overhead which can lower the overall quality for the media.

It is also possible to consider a solution where a base media quality is calculated and the network related parameters degrading the quality are subtracting a value from the score and the robustness related parameters are adding (or subtracting) another value to the score.

The quality score, according to a further embodiment, can be estimated momentarily or as a function over a certain time. If the quality score is estimated momentarily a sliding window has to be used for many of the parameters, such as BLER and actual frame rate, to avoid peak values that will give quality scores that are not representative for the perceived quality. The sliding window can for example be 8 seconds long; long enough to avoid misrepresentative peaks but still short enough to avoid too flattening averaging effects.

For illustrative reasons a quality score function based on a small subset of the described parameters has been tested in a video telephony quality model. The model has been mapped to the results of a subjective test where a group of test subjects were grading short video telephony sequences encoded and degraded with different video codecs, target video frame rates and radio BLER. The following function Equation 7, was used for the model:

$$M O {S}_{pred} = \{ \begin{matrix}{β}_{0} + {β}_{1} \cdot B L E R & if B L E R < threshold \\ 1 & if B L E R > threshold\end{matrix} \qquad ( 7 )$$

where 0≦BLER≦1 and β=(β₀,β₀). Different values for β were used for the different video codecs. In the above describer example β₀ represents the parameter related to the clean coded media quality and β₁ represents the parameter corresponding to the network degradation.

According to a further model (taking more then two parameters into consideration), the above example function can be refined according to Equation 8 below:

$$M O {S}_{pred} = \{ \begin{matrix}{β}_{0} + {β}_{1} \cdot ( {β}_{2} + {β}_{3} \cdot B L E R ) & if B L E R < threshold \\ 1 & if B L E R > threshold\end{matrix} \qquad ( 8 )$$

Using the same terminology as described above one could say that β represents the quality of the clean coded media while BLER represents the quality degradation introduced by the CS network.

The present invention can also provide mapping to the results from other objective models to improve the inventive model.

The model of the present invention can be used to monitor the quality of a real two-way video telephony phone call. It can also estimate the quality when a video telephony stream is sent over a network one-way. This is suitable when testing the video telephony service in a network.

The model is a parametric model based on parameters from the radio network, transport network as well as audio and video coding parameters. Possible parameters include radio block error ratio (BLER), radio bearer, packet loss, used audio and video codecs, video frame rate and video quantizers. However, for some instances the model can be regarded as a bitstream model. The difference lies in if the model utilizes only provided parameters without decoding (partly of fully) the actual media, or if also at least partly decoded media is utilized.

Parameters are preferably extracted and collected in real-time and a quality score is calculated using the disclosed model. The score can for example be an estimation of MOS. The model is used with advantage in a circuit switched (CS) mobile network but can also be used in a packet switched (PS) network or a combination of the two.

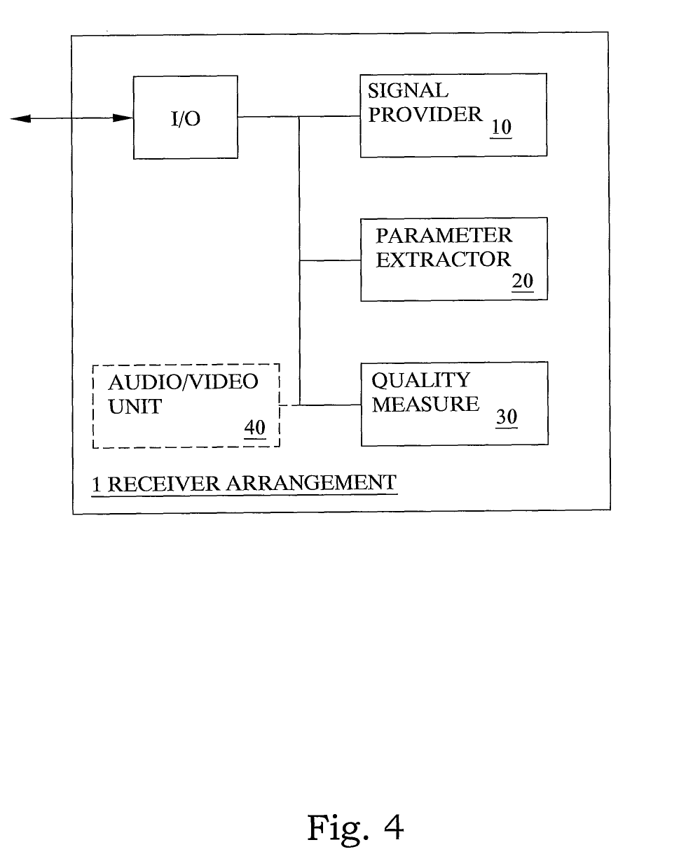

A receiver arrangement for enabling the above described embodiments of a method according to the present invention will be described with reference to FIG. 4 (and FIG. 1, FIG. 2).

The arrangement 1 for quality assessment of a multimedia signal comprising video telephony media in a video telephony system, comprises a unit 10 for receiving the multimedia signal from a transmitting unit, a unit 20 for extracting multiple parameters from said multimedia signal. The extracting unit is adapted to extract parameters comprising both parameters indicative of transmission conditions as well as specific coding related parameters. In addition, the arrangement 1 comprises a quality determining unit 30 for determining an objective quality measure for the video telephony media based on representations of some or all of the extracted parameters.

The extracting unit 20 can be further adapted for extracting the parameters from an at least partly decoded segment of the video telephony media, or alternatively adapted for extracting the parameters from a fully decoded segment of the video telephony media.

In addition, the arrangement may comprise a unit 40 for supporting processing of audio/video content of the multimedia signal.

In summary, the present invention discloses a parametric model that does not require that the media of the video telephony stream is fully decoded to objectively (or subjectively) estimate its quality. The algorithm is therefore computationally efficient and can with advantage be implemented for real-time usage with low demands on hardware performance. This is often a challenging task for algorithms based on video image analysis.

Since the model can use many important quality parameters from the network and from the coding, a probable cause for the quality degradation can be determined with high accuracy.

Many of the known algorithms based on image analysis require a reference video for comparison. The present invention does not compare and is therefore not facing the problems where exact frame synchronization between reference and test sequence is needed.

The present invention discloses that a quality score is calculated for audio quality, video quality and/or a total quality for a video telephony service. This also separates the invention from models only using video image analysis.

Parametric models, like taught by the invention, if properly trained have the option of giving the average score for all typical video contents for video telephony. A video image analysis model, unlike the present parametric model, will always give the score for a certain video content. In a test situation the average of all content is often what is wanted, since a mobile video telephony user will experience the quality of the content he receives at that point, and there is no way of knowing exactly what content it is. The average score will give the average satisfaction of video telephony users.

It will be understood by those skilled in the art that various modifications and changes may be made to the present invention without departure from the scope thereof, which is defined by the appended claims.

### REFERENCES

[1] PEVQ from Opticom. http://www.opticom.de
[2] VQuad and Vmon algorithms from SwissCal. http://www.swissqual.com
[3] Optimacy tool from Genista. http://www.genista.com

1. A method of quality assessment for a multimedia signal comprising video telephony media in a video telephony system, comprising the steps of:
receiving said multimedia signal;
extracting a plurality of parameters from said multimedia signal, and
determining an objective quality measure for said video telephony media based on representations of at least three of said extracted parameters, said at least three parameters including at least one of each of coding parameters, network parameters and robustness parameters.

2. The method according to claim 1, wherein said determining step comprises calculating said objective quality measure according to the formula:
Qual_{pred}=ƒ(c,n,r)
Where, Qual_{pred} is the quality measure or score, ƒ is a predetermined selected function, c is a representation of extracted coding parameters, n is a representation of extracted network parameters and r is a representation of extracted parameters affecting the robustness of the media.

3. The method according to claim 1, wherein said plurality of parameters are extracted from an at least a partly parsed segment of the multimedia signal.

4. The method according to claim 1, wherein said plurality of parameters are extracted from a fully parsed segment of the multimedia signal.

5. The method according to claim 1, wherein said network parameters comprise both radio network parameters and transport network parameters.

6. The method according to claim 5, wherein said radio network parameters are selected from the group consisting of radio BLER and radio bearer type.

7. The method according to claim 5, wherein said transport network parameters are selected from the group consisting of packet loss, data throughput, packet jitter data, jitter buffer strategy, IP packet size, and RTPI RTCP signaling.

8. The method according to claim 1, wherein said coding parameters comprise codec information.

9. The method according to claim 8, wherein said codec information is selected from the group consisting of audio codec, video codec, video codec profile, and video codec level.

10. The method according to claim 1, wherein said coding parameters comprise audio coding dependent parameters.

11. The method according to claim 10, wherein said audio coding dependent parameters are selected from the group consisting of audio codec mode and use/nonuse of DTX.

12. The method according to claim 1, wherein said coding parameters comprise video coding dependent parameters.

13. The method according to claim 12, wherein the step of selecting video coding dependent parameters requires partial bit parsing of the video telephony session, and from the group of picture quantizer, actual video frame rate, number of video segments, intra/inter picture, coding tools.

14. The method according to claim 12, wherein the step of selecting video coding dependent parameters requiring full bit parsing of the video telephony session, and from the group of number of intra macroblocks per picture, intra refresh strategy, differential quantizer and average/min/max quantizer per picture, number of macroblocks per segment, average, max and min absolute motion vectors.

15. The method according to claim 1, wherein said parameters comprise codec independent parameters.

16. The method according to claim 15, wherein said codec independent parameters are selected from the group consisting of: CRC error ratio for audio and video, number of CRC error for audio and video, total bitrate, video bitrate, audio bitrate, number of bits per video frame, audio-video synchronization time difference, target video frame rate, and video type.

17. The method according to claim 1, wherein said extracted parameters are selected from the group consisting of: radio BLER, packet loss, total bitrate, audio-video synchronization time difference, target video frame rate, audio codec, video codec, audio codec mode, and picture quantizer for said video telephony session.

18. The method according to claim 1, wherein said quality measure is indicative of at least one from the group of video quality, audio quality and total quality for the video telephony payload.

19. The method according to claim 18, wherein said quality measure provides separate indications of video quality, audio quality and total quality.

20. An arrangement for quality assessment of a multimedia signal comprising video telephony media in a video telephony system, comprising:
means for receiving said multimedia signal;
means for extracting a plurality of parameters of said multimedia signal, and
means for determining an objective quality measure for said video telephony media based on representations of at least three of said extracted parameters, said at least three parameters comprising extracted coding parameters, extracted network parameters and extracted robustness parameters.

21. The arrangement according to claim 20, wherein said extracting means are adapted for extracting said plurality of parameters from an at least partly parsed segment of the video telephony media.

22. The arrangement according to claim 20, wherein said means for extracting are adapted for extracting said plurality of parameters from a fully parsed segment of the video telephony media.

23. The arrangement according to claim 20, further comprising means for supporting processing of signals including audio and video content.
